(19) United States
(12) Patent Application Publication
(10) Pub. No.: US 2002/0095330 A1
(43) Pub. Date: Jul. 18, 2002

(54) Audio Advertising computer system and method

(76) Inventors: Stuart Berkowitz, Toronto (CA); Liang Shen, North York (CA); Ningyan Liu, North York (CA); Robert Marchand, King City (CA)

Correspondence Address: Jones, Day, Reavis & Pogue, North Point, 901 Lakeside Avenue, Cleveland, OH, 44114, US

(21) Appl. No.: 09/759,829

(22) Filed: Jan. 12, 2001

(51) Int. Cl. G06F 17/60

(52) U.S. Cl. 705/14; 705/37; 705/10

(57) ABSTRACT

A computer-implemented audio advertising system for providing audio advertisements to users over a network. An advertising management server receives audio advertisements and advertisement account data over the network. An advertising database stores the audio advertisements and advertisement account data. Upon requests from telephony services, an advertising selection and retrieval server fetches audio ads according to a set of effective searching criteria. The retrieved audio ad is played to users of the telephony services.

### BACKGROUND

1. Technical Field

The present invention is directed to the field of computer advertising systems. More specifically, the present invention is directed to a computer audio advertising systems.

2. Description of the Related Art

The Internet provides a myriad of “free” services to its users. Users may search for Internet content using such “free” web sites as Yahoo or Infoseek. People's addresses or phone numbers or map directions are also freely provided on the Internet. Many newspaper web sites can be browsed at no cost. Users have grown accustomed to free services.

Due to a vastly different infrastructure, wireless communication systems have difficulty providing truly free services to its users. To heighten the difficulty, new technologies are continuously emerging to enhance services provided by wireless communication systems. For example, voice markup languages have been introduced that make available the services of the Internet to wireless communication users. One such voice markup language is VoiceXML which permits users to interact with Internet web pages using an audio interface (such as a cellular communication device).

An example of a VoiceXML application is a restaurant locating application with which a user can communicate in order to locate a restaurant in a certain city. Such interaction includes asking the user questions, such as to the type of restaurant and location. Another VoiceXML application may interact with the user to provide directions to the restaurant. The VoiceXML application typically resides on an Internet web site. A telephony server acts as an interface with the web site and allows the VoiceXML application to interact with the user.

The ever increasing sophistication of wireless communication systems as shown by the advent of VoiceXML technology renders it more difficult for such systems to provide “free” services to their users. Users have been exposed by the Internet to free services and expect to have free services with their wireless communication systems.

### SUMMARY

The present invention satisfies the aforementioned needs of wireless communication users as well as other needs. In accordance with the teachings of the present invention, a computer-implemented audio advertising system provides audio advertisements to users of telephony services. An advertising management server receives audio advertisements and advertisement account data over the network. An advertising database stores the audio advertisements and advertisement account data. Upon requests from the telephony services, an advertising selection and retrieval server fetches audio ads according to a set of effective searching criteria. The retrieved audio ad is played to users of the telephony services.

### BRIEF DESCRIPTION OF THE DRAWINGS

FIG. 1 is a block diagram that depicts the advertising management computer system of the present invention;

FIG. 2 is a block diagram that depicts the advertising selection and retrieval computer system of the present invention;

FIG. 3 is a block diagram that depicts the revenue sharing system of the present invention;

FIG. 4 is a flowchart that depicts steps to process an advertising request from an advertiser; and

FIGS. 5 and 6 are flowcharts that depict steps to process an incoming customer's call in accordance with the teachings of the present invention.

### DETAILED DESCRIPTION OF THE PREFERRED EMBODIMENT

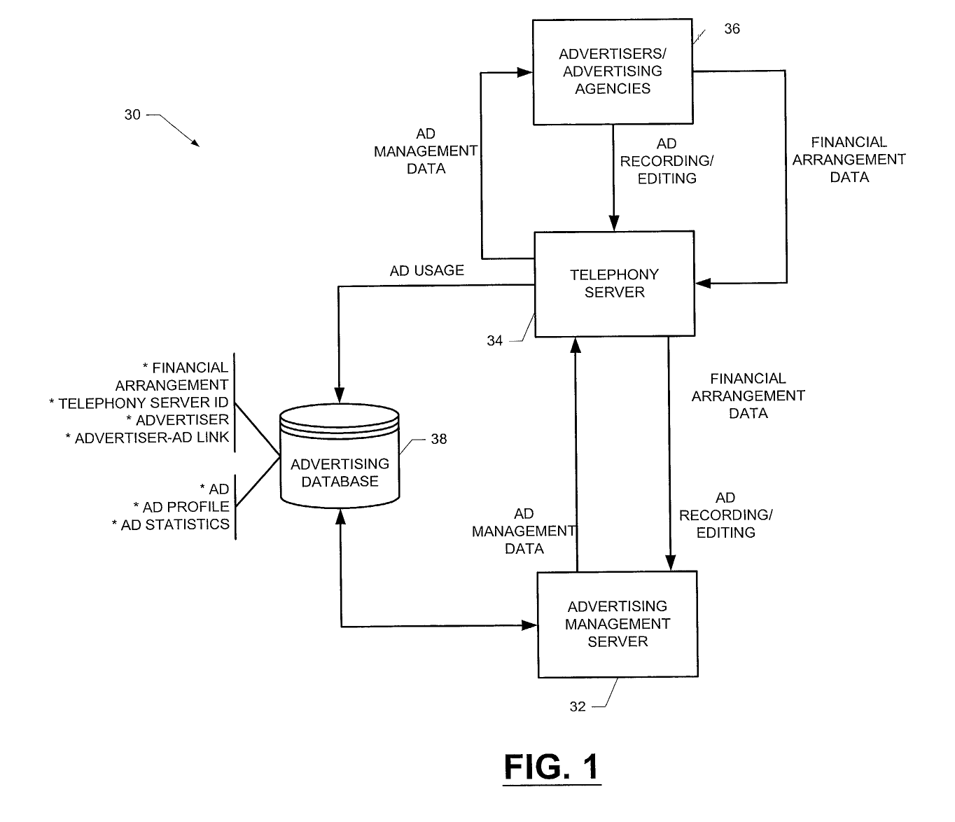

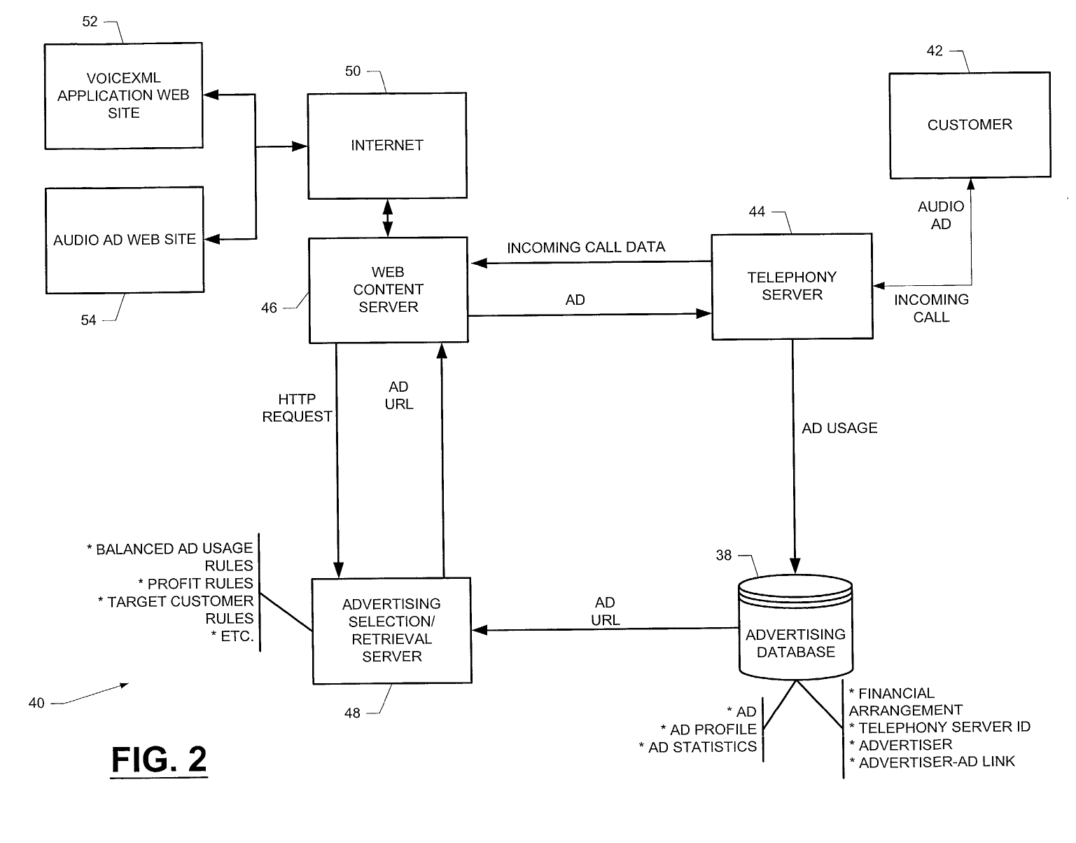

FIGS. 1 and 2 are system block diagrams that depict the computer-implemented components of the present invention. The present invention manages and selects audio advertisements for use in a telephony environment. Ad recordings and ad edits submitted by advertisers are managed by an advertising management server. An advertising selection/retrieval server provides an appropriate audio ad to an end-user based upon ad selection criteria.

FIG. 1 depicts the advertising management computer system of the present invention as shown generally at 30. The advertising management computer system 30 provides for the self-management of audio advertising via telephony servers by providing such features as advertisers defining the relationship for their ad delivery as well as advertisers uploading their own advertising content.

The advertising management server 32 receives ad recordings and ad edits from a telephony server 34. Advertisers and advertising agencies 36 (i.e., ad providers) are possible sources of these ad recordings and ad edits. The advertising management server 48 provides a set of web user interfaces, network communication ports, and phone user interfaces so that the advertisers and advertising agencies may interact with server 48. It should be understood that the advertising management server 32 and the advertising retrieval server 48 may operate upon the same computer or operate upon different computers depending upon the application at hand.

The ad recordings may be an audio recording of an ad lasting from several seconds to several minutes. In one embodiment, the advertising management server 32 does not receive from the advertisers 36 the actual audio ad file, but instead an identifier for locating the audio file on a network. The network may be a local area network, a wide area network, or a global network (such as the Internet). An example of an identifier is a Uniform Resource Location (URL) identifier that identifies where on the Internet the audio file is located. It should be understood that the present invention also includes the URL indicating that the location of the audio file is within the advertising database 38.

Moreover, the format of the audio file may vary greatly. The audio file may be in a WAVE format or some other format, provided that the format is ultimately able to be played to a customer.

The advertising management server 32 stores the ad recording in the advertising database 38. The advertising management server 32 collects and stores information in addition to the ad recording. Such information includes the identity of the advertiser who stored the ad recording, when the ad recording was stored, the format of the audio file, and profile of customers potentially interested in listening to the ad.

The present invention also collects the type of financial arrangement that is to be associated with the playing of the ad. For example, an advertiser may wish to pay a set amount each time the ad is played to a customer. Another advertiser may wish to pay for the playing of the ad by sharing its revenues with the advertising management server's owner that are attributable to the product being advertised. In still another way, the advertiser may pay a set fee amount regardless of how often the ad is played. In this way, the present invention is highly adaptable to a number of financial arrangements.

The advertising management server 32 also processes modifications or edits to the ad recording information, such as by placing a new ad location identifier that locates the most recent version of an ad. Such an approach eases the ad updating process. The advertiser 36 may also select the date and/or times that a particular ad should run. Thus, one type of ad may be used for a particular product before evening time, and another type used during and after evening hours.

FIG. 2 depicts the advertising selection and retrieval computer system as generally shown at 40. The advertising selection and retrieval computer system of the present invention ensures delivery of the ad to the customer. It should be understood that the advertising management server and advertising selection and retrieval server are preferably implemented as separate computer servers, but may be implemented on the same server depending upon the application at hand.

The present invention retrieves audio ads from the advertising database 38 in response to an incoming call from a customer 42. The customer may be using a telephone or a wireless communication device to have a service performed for the customer 42. An example of a service includes the telephony server 44 receiving a call from the customer 42 so that the customer 42 may locate a restaurant in a certain city. The telephony server 44 uses the web content server 46 to access a restaurant-locating software application that is on a network, such as the Internet 50. The application may be a VoiceXML application located on a remote web site 52. Another exemplary application includes a customer 42 calling to locate the phone number of another individual. In this latter example, the application is a phone number lookup VoiceXML application.

The telephony server 44 forwards the incoming call to a web content server 46. The web content server 46 formulates a hypertext transfer protocol (http) request for an audio ad. The request is sent to the advertising selection/retrieval server 48 for processing. The advertising selection/retrieval server 48 selects an appropriate audio ad from the advertising database 38 and sends back an ad location identifier to the web content server 46. The web content server 46 retrieves the audio file from a web site 54 based upon the ad location identifier and dynamically inserts the ad audio file into the VoiceXML application. The web content server 46 performs the functions of the VoiceXML application and then plays the audio file through the telephony server 44 for the customer.

The web content server 46 may include in the http request such information as the type of customer that is placing the incoming call. The web content server 46 knows what type of customer is placing the incoming call based upon information that the customer has already provided to the telephony server 44. For example, the telephony server 44 may know where the customer is located based upon the area code of the incoming call or the telephony server 44 has a database that stores profiles of its customers. The customer's request may also furnish additional information. For example, if the customer is requesting jewelry information, then the web content server 46 may supplement the http request with that profile information. In such a situation, the advertising selection/retrieval server 48 may heighten the probability that a jewelry-related audio ad be selected. The telephony server 44 may also have asked the customer questions about the customer's profile.

The advertising selection/retrieval server 48 selects an audio ad based upon certain predetermined rules. The ad selection rules include: balanced ad usage rules, profit rules (e.g., revenue sharing rules), target customer profile rules, and other selection rules that will be apparent to one skilled in the art. The balanced ad usage rules ensure that audio ads are played at least a certain amount of times. The profit rules optimize the amount of earnings the operators of the present invention acquire for the playing of the audio ads. For example, the profit rules may indicate that a first audio ad be played more often than a second audio ad when the first audio ad's financial arrangement is based upon a profit-sharing arrangement, and the second audio ad's financial arrangement is a set fee arrangement. The target customer profile rules ensure that audio ads that fit a customer profile are played. For example, a jewelry-related audio ad is played for a customer who has requested jewelry-related information. Examples of other selection rules include accounting information (such as whether the advertiser is current in its payments to the operators), application service provider configuration, and content provider configuration.

The telephony server 44 provides ad usage data which is stored in the advertising database. The telephony server 44 records how long an audio ad was played to a customer 42. A customer 42 may terminate the call before the entire audio ad was played. The ad usage information is sent to advertisers to provide feedback on the quality of their ads. For example, if a certain ad is habitually terminated early by customers, then this serves as an indication that the ad may need to be improved or replaced.

The present invention operates with free content providers. In this context, the system of the present invention is entitled to a certain number of minutes (i.e., four minutes) of its own ad for every time slot (e.g., twenty-two minutes) while the application service provider provides a piece of time for its own ad. In other words, for every block of time, say thirty minutes, the content provider can use only twenty-two minutes of that time block while keeping the remaining four minutes for its own ad and four minutes for the application service provider.

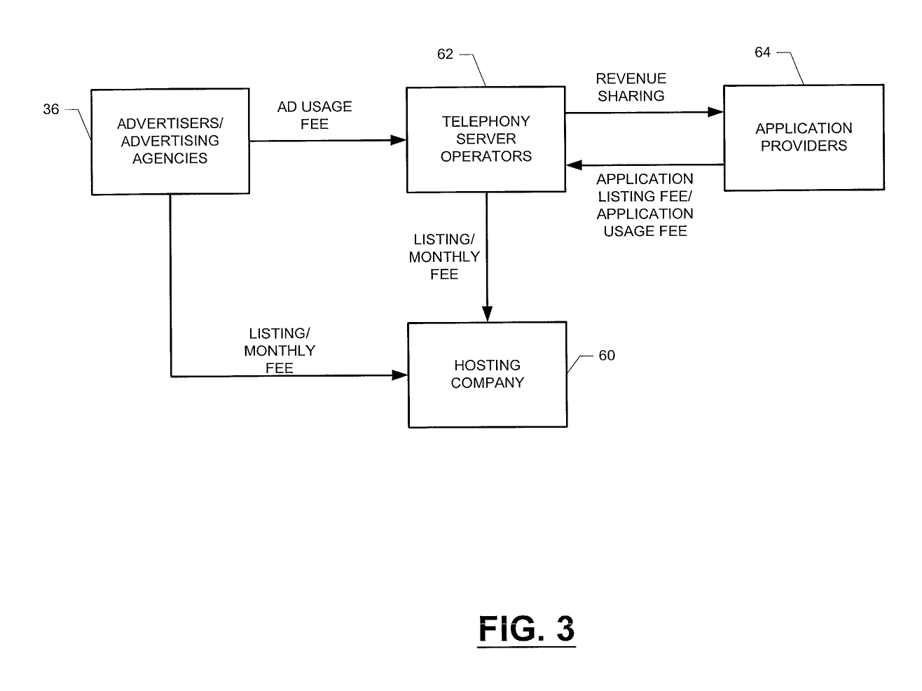

FIG. 3 is a block diagram that depicts the revenue sharing system of the present invention. The hosting company 60, who owns the advertising servers charges a one time listing fee and monthly platform usage fees from advertising agencies 36 and telephony server operators 62. The advertising agencies 36 pay the hosting company 60 with the listing fee and monthly platform fee, and pay the telephony server operators 62 the ad usage fee.

The telephony server operators 62 pay the hosting company 60 the listing and monthly platform fees and receive the ad usage fees from matched advertisers. The telephony server operators 62 distribute the ad fees with the connected application providers 64, and charge the application providers 64 the application usage/listing fees.

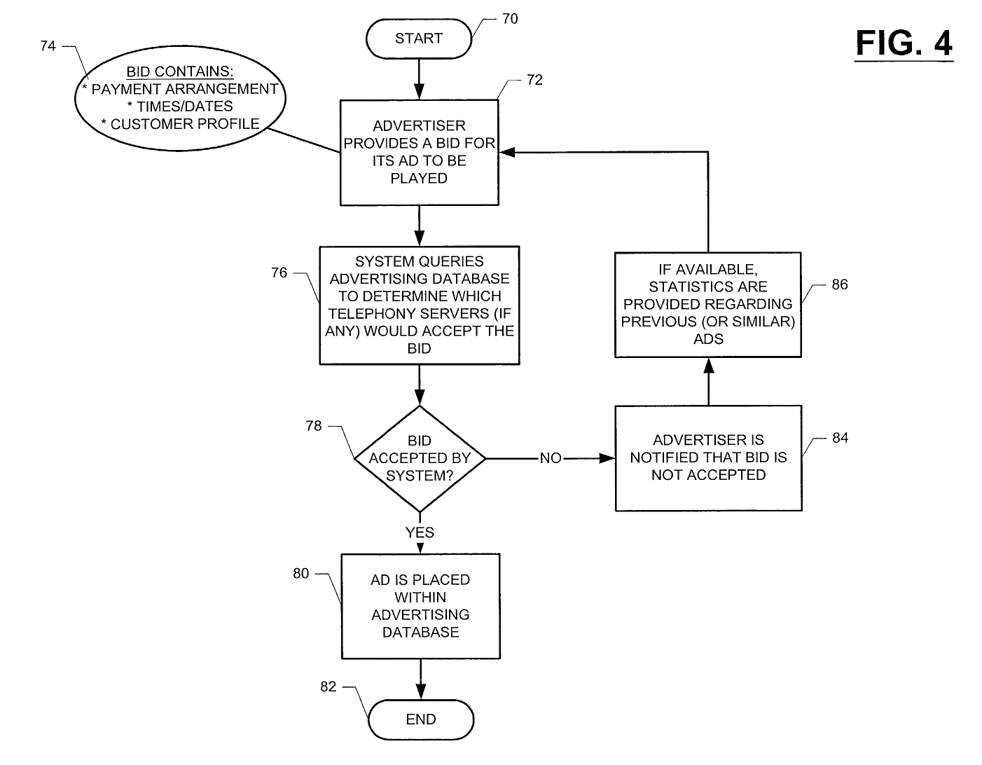

FIG. 4 is a flowchart depicting steps to process an advertising request from an advertiser. The start indication block 70 indicates that process block 72 is to be performed. At process block 72, an advertiser provides a bid 74 so that its ad may be played. The advertiser's bid 74 may contain the payment arrangement, the times and dates the ad should be played, and the customer profile.

At process block 76, the system of the present invention queries the advertising database to determine which telephony servers (if any) are willing to accept the advertiser's bid 74. As discussed above, the system may accept the bid 74 if the bid 74 contains a payment amount that at least one of the telephony servers finds satisfactory. A telephony server may be more willing to accept a lesser amount to play an ad if the advertiser allows the ad to be played during non-premium times. An example of a non-premium time includes the time between midnight and 6:00 a.m. The telephony servers may also adjust their asking prices based upon the service or VoiceXML application to be provided to the customer. A more sophisticated VoiceXML application may warrant a higher asking price.

A telephony server may also provide a range of acceptable prices to advertisers. The telephony server may remain fixed at a certain higher price for two bidding iterations with an advertiser, then negotiate downward to its lower range price for subsequent iterations.

If the system accepts the bid as determined by decision block 78, then process block 80 places the ad (or its location identifier) and its accompanying data (e.g., customer profile data) within the advertising database. Processing terminates at end block 82.

However, if the system does not accept the bid as determined by decision block 78, then process block 84 notifies the advertiser that the bid is not accepted and the basis for non-acceptance. Such a basis may include the payment amount as specified in the bid 74 being insufficient or that the times and dates are not available for playing the ad. The system may further supplement its notification of non-acceptance by providing (if available) statistics at process block 86 to the advertiser. An example of the type of statistics provided to the advertiser includes what the average payment amount is for an ad similar to the ad that the advertiser wishes to play. Another example includes statistics on how well other ads placed by the advertiser had fared. If other ads by the advertiser have a low ad usage rate due to customers habitually terminating the audio playing of the ad, then the system may expect a higher payment for playing this new ad of the advertiser. Still other statistics are included within the scope of the present invention as are apparent to one skilled in the art. The bid/ask process is iterated until the bid is accepted by the system or the advertiser does not provide a further bid.

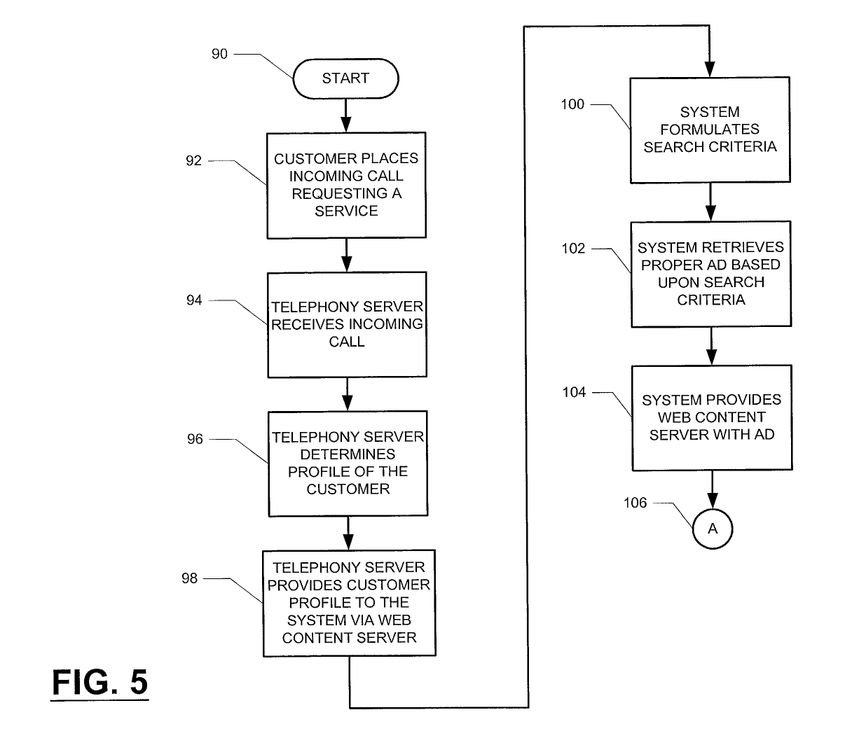

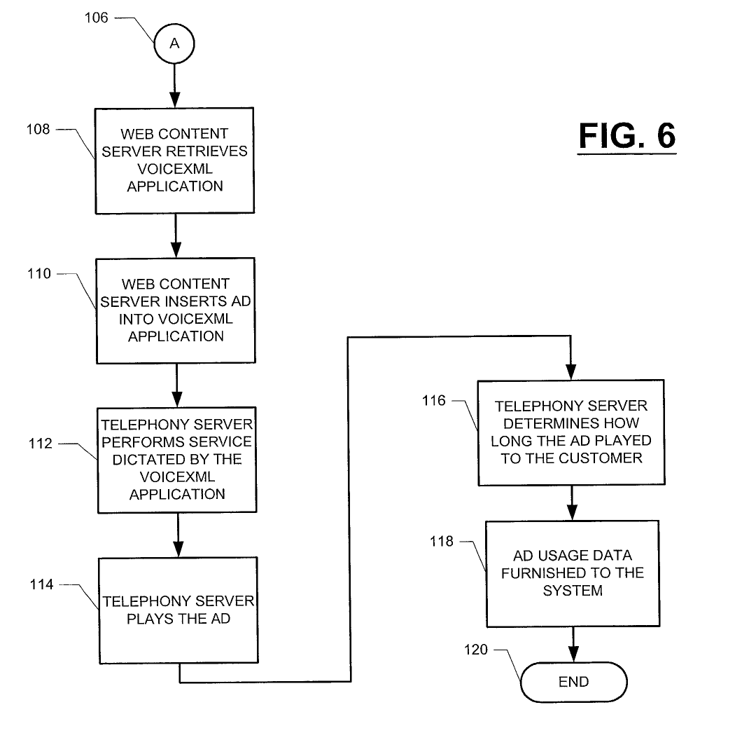

FIGS. 5 and 6 are flowcharts that depict steps to process an incoming call in accordance with the teachings of the present invention. Start indication block 90 indicates that process block 92 is performed. At process block 92, a user/customer places a call in order to request a service. A telephony server receives the incoming call at process block 94.

At process block 96, the telephony server determines the profile of the customer, and process block 98 provides the customer profile to the system via the web content server. Process block 100 includes the system formulating the search criteria based upon the information provided by the telephony server and the preselected rules. The system retrieves at process block 102 the proper ad based upon the search criteria and provides the web content server with the ad at process block 104. Continuation block 106 indicates that processing continues at process block 108 on FIG. 6.

With reference to FIG. 6, process block 108 retrieves via the web content server the proper VoiceXML application in order to service the request of the customer. At process block 110, the web content server inserts the ad into the VoiceXML application. The telephony server at process block 112 performs the service as dictated by the VoiceXML application.

The ad is played to the customer at process block 114. At process block 118, the telephony server determines how long the ad was played to the customer, and that information is provided to the system of the present invention at process block 118. Processing terminates at end block 120.

The preferred embodiment described with reference to the drawing figures is presented only to demonstrate an example of the invention. Additional and/or alternative embodiments of the invention will be apparent to one of ordinary skill in the art upon reading this disclosure. For example, the above discussion mentioned VoiceXML applications as providing services requested by customers. It should be understood that the present invention includes using any software application (including other voice markup language applications) that can be used to supply services to customers whether the customers are on a wireless communication device (such as a hand-held cellular communication device) or on their computers.

It is claimed:

1. A computer-implemented audio advertising method for providing audio advertisements to users of telephony services, comprising the steps of:
receiving bid data from advertisement providers over a network, wherein an audio advertisement is played over the network if the bid data is determined satisfactory;
receiving asking data over the network to determine whether the bid data is satisfactory;
determining whether the bid data is satisfactory based upon a comparison between the bid data and the asking data; and
storing an audio advertisement after the bid data has been determined satisfactory, wherein the stored audio advertisement is played over the network to the users of the telephony services.

2. The method of claim 1 further comprising the steps of:
determining that the bid data is unsatisfactory based upon the comparison;
receiving second bid data from the advertisement providers over the network;
determining whether the second bid data is satisfactory based upon a comparison between the second bid data and the asking data; and
storing the audio advertisement after the second bid data has been determined satisfactory, wherein the stored audio advertisement is played over the network to the users of the telephony services.

3. The method of claim 1 wherein the bid data includes a financial arrangement regarding payment for playing the audio advertisement.

4. The method of claim 3 wherein the financial arrangement includes a revenue-sharing financial arrangement.

5. The method of claim 1 further comprising the steps of:
storing a plurality of audio advertisements in a database;
receiving a request to retrieve at least one of the stored audio advertisements;
retrieving at least one of the stored audio advertisements based upon predetermined selection rules,
wherein the retrieved audio advertisement is played over the network to the users of the telephony services.

6. The method of claim 5 wherein the request includes a user profile, said method further comprising the step of:
retrieving at least one of the stored audio advertisements that substantially matches the user profile provided in the request.

7. The method of claim 5 wherein the selection rules include balanced ad usage rules that are used to determine which stored audio advertisement to retrieve.

8. The method of claim 5 wherein the selection rules include profit rules that are used to determine which stored audio advertisement to retrieve.

9. The method of claim 1 wherein a user uses a telephony server to access a service that is located on the network, said method further comprising the step of:
providing the service and the stored audio advertisement to the user.

10. The method of claim 9 wherein the service is a voice markup language application located on the Internet.

11. The method of claim 9 wherein the stored audio advertisement is an audio file containing an advertisement.

12. The method of claim 9 wherein the stored audio advertisement is a location identifier to locate an audio file on the network.

13. The method of claim 1 further comprising the steps of:
receiving ad usage data about the playing of the stored audio advertisement to the users; and
providing the ad usage data to the advertisement providers, wherein the advertisement providers formulate bid data based upon the ad usage data.

14. A computer-implemented audio advertising system that provides audio advertisements to users of telephony services over a network, comprising:
a database that stores audio advertising data;
an advertising retrieval server with a data connection to the database,
wherein the advertising retrieval server retrieves audio advertising data based upon predetermined selection rules; and
a network port with a connection to the advertising retrieval server and to the network, wherein the network port provides a data communication pathway so that an advertisement may be played over the network to the users of the telephony services based upon the retrieved audio advertising data.

15. The audio advertising system of claim 14 wherein the audio advertising data is an audio file containing the advertisement.

16. The audio advertising system of claim 14 wherein the audio advertising data includes a location identifier to locate an audio file on the network.

17. The audio advertising system of claim 16 wherein the network is an Internet network.

18. The audio advertising system of claim 17 wherein the location identifier is a Uniform Resource Location (URL) that identifies on a remote computer on the Internet network an audio file containing the advertisement to be played.

19. The audio advertising system of claim 14 wherein a request is provided to the advertising retrieval server to provide the advertisement to the users of the telephony services.

20. The audio advertising system of claim 19 wherein the request includes a user profile, wherein the advertising retrieval server retrieves stored audio advertising data from the database that substantially matches the user profile provided in the request.

21. The audio advertising system of claim 19 wherein the selection rules include balanced ad usage rules that are used to determine which stored audio advertising data to retrieve.

22. The audio advertising system of claim 19 wherein the selection rules include profit rules that are used to determine which stored audio advertising data to retrieve.

23. The audio advertising system of claim 14 further comprising:
an advertising management server that includes a network port in data communication with the network, wherein the advertising management server receives bid data from advertisement providers over the network, wherein the audio advertisement is played over the network if the bid data is determined satisfactory.

24. The audio advertising system of claim 23 wherein the advertising management server receives asking data over the network to determine whether the bid data is satisfactory.

25. The audio advertising system of claim 24 wherein the bid data is satisfactory based upon a comparison between the bid data and the asking data.

26. The audio advertising system of claim 24 wherein ad usage data is collected about the playing of the advertisement to the users, wherein the asking data is formulated based upon the ad usage data.

27. The audio advertising system of claim 24 wherein the advertising management server and the advertising retrieval server operate upon the same computer.

28. The audio advertising system of claim 24 wherein the advertising management server and the advertising retrieval server operate upon different computers.

29. The audio advertising system of claim 14 wherein a user uses a telephony server to access a service that is located on the network, wherein the advertising retrieval server provides the service and the advertisement to the user.

30. The audio advertising system of claim 29 wherein the service is a voice markup language application located on the Internet.
